(19) United States
(12) Patent Application Publication
(10) Pub. No.: US 2018/0023578 A1
(43) Pub. Date: Jan. 25, 2018

(54) FAN SHROUD, FAN DEVICE, AND MANUFACTURING PROCESS

(71) Applicant: DENSO International America, Inc., Southfield, MI (US)

(72) Inventor: Joseph Charles Burtch, Farmington Hills, MI (US)

(21) Appl. No.: 15/215,892

(22) Filed: Jul. 21, 2016

(51) Int. Cl. F04D 25/06; F01P 5/02; F04D 29/52; B60K 11/06; F04D 29/64; F04D 29/32

(52) U.S. Cl. CPC F04D 25/0693; F04D 29/644; F04D 29/325; F04D 29/526; B60K 11/06; F01P 5/02

(57) ABSTRACT

A shroud body has a hollow space. A shroud ring is located in the hollow space. Multiple arms radially extend in the hollow space and connect the shroud body with the shroud ring. Multiple terminals are electrically conductive and are equipped to the shroud ring. Multiple wires are electrically connected with the terminals. At least one of the wires is integrally molded with at least one of the arms.

### TECHNICAL FIELD

The present disclosure relates to a fan shroud, a fan device having the fan shroud, and a manufacturing method for the fan shroud.

### BACKGROUND

A fan module is generally equipped to a vehicle for cooling heat exchanger such as a radiator and a condenser. The fan module includes a shroud equipped with an electric motor to drive a fan to produce an airflow.

A fan module is equipped with electric wires to connect a motor with an external connector to supply electric power to the motor. The wires may be bundled together and may be routed on the surface of the shroud. Consequently, the wires may be laid on a lengthy path from the motor to the connector. In actual use, the wires may be detached from the shroud and may be tangled into a shaft of the fan. The wires may be exposed to heat of engine components and may be deteriorated.

### SUMMARY

It is an object of the present disclosure to produce a fan shroud configured to restrict wires from detachment from a shroud body. It is another object to produce a fan device having the fan shroud and to produce a manufacturing method for the fan shroud.

The present disclosure addresses the above-described concerns. According to an aspect of the preset disclosure, a shroud body may have a hollow space. A shroud ring may be located in the hollow space. A plurality of arms may radially extend in the hollow space and may connect the shroud body with the shroud ring. A plurality of terminals may be electrically conductive and may be equipped to the shroud ring. A plurality of wires may be electrically connected with the terminals. At least one of the wires may be integrally molded with and maybe embedded in at least one of the arms.

### BRIEF DESCRIPTION OF THE DRAWINGS

The above and other objects, features and advantages of the present invention will become more apparent from the following detailed description made with reference to the accompanying drawings. In the drawings:

FIG. 1 is a top view showing a fan device;

FIG. 2 is a top view showing the fan device excluding a fan;

FIG. 3 is an exploded perspective view showing components of the fan device;

FIG. 4 is an exploded side view showing components of the fan device;

FIG. 5 is a side view showing the fan device being assembled;

FIG. 6 is a perspective view showing a wire harness in a molding die;

FIG. 7 is a top view showing a fan device according to a second embodiment; and

FIG. 8 is a top view showing a fan device according to a third embodiment.

### DETAILED DESCRIPTION

### First Embodiment

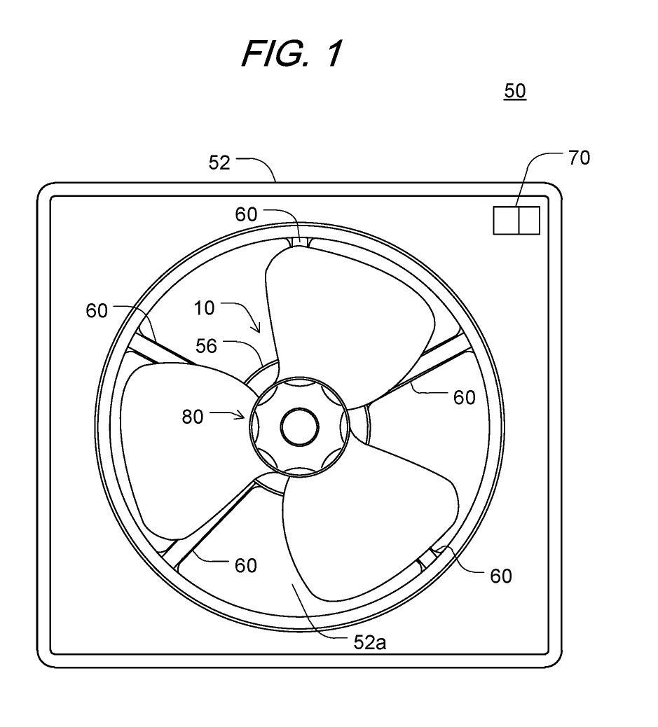

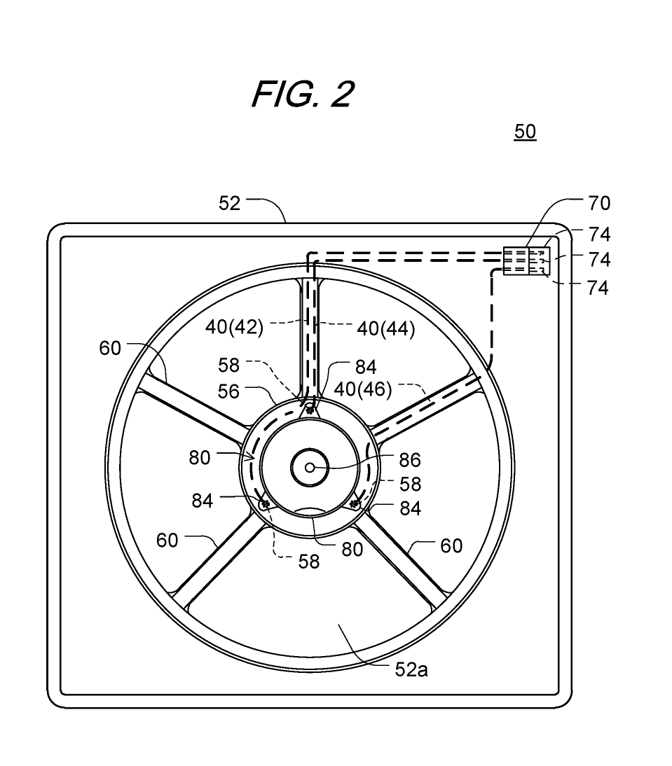

As follows, a first embodiment of the present disclosure will be described with reference to drawings. As shown in FIGS. 1 and 2, a fan device includes a fan shroud 50, a motor 80, and a fan 10. The fan device is equipped to, for example, an engine compartment of a vehicle. The fan device may be combined with a condenser and a radiator to form a condenser, radiator, and fan module (CRFM).

The fan shroud 50 includes a shroud body 52, a shroud ring 56, multiple arms 60, and a connector 70. In the present example, the shroud body 52, the shroud ring 56, the arms 60, and the connector 70 are integrally molded of resin such as ABS resin. The shroud body 52 has a circular hollow space 52a at the center. The shroud ring 56 is located at the center of the hollow space 52a. The arms 60 radially extend in the hollow space 52a from the outer circumferential periphery of the shroud ring 56 to the inner circumferential periphery of the shroud body 52. The arms 60 connect the shroud body 52 with the shroud ring 56. The arms 60 form a spoke structure in a star shape to suspend the shroud ring 56 in the hollow space 52a. In the present example, the arms 60 include five arms 60 located at a constant angular interval of 72 degrees. The arms 60 form passages in the hollow space 52a to enable air to flow therethrough in the thickness direction of the fan shroud 50.

For example, the connector 70 is raised from a front surface of the shroud body 52. The connector 70 has a socket structure to receive an external cable. The connector 70 includes connector pins 74, which are electrically conductive. The connector 70 is to be connected with the external cable on the side of the vehicle.

The motor 80 is, for example, a direct-current brushless motor 80. More specifically, the motor 80 includes a motor body 81 including a rotor, a stator, a hall element, and internal windings, which are accommodated in a motor cover 82. The internal windings of the motor 80 are conceded with a positive, a negative wire, and a signal wire. Internal windings for generating a magnetic field are wound around the stator and are configured to produce a magnetic field on receiving a direct current through the positive and negative wires. In this way, the internal windings and the stator rotates the rotor, which is equipped with a shaft 86. The hall element detects a rotational position of the rotor and sends a detection signal through an internal wiring, which is connected with the signal wire. The detection signal may be sent to an external controller such as an electronic control unit (ECU). The ECU may control the direct current supplied to the motor 80 according to the detection signal. The motor 80 is equipped to the shroud ring 56 and supported by the fan shroud 50 body via the shroud ring 56 and the arms 60.

The fan 10 has multiple blades. The fan is equipped to the shaft 86 of the motor 80. In the present structure, the fan 10 is driven by the motor 80 thereby to produce an airflow to pass through the airflow passage formed in the hollow space 52a of the shroud body 52.

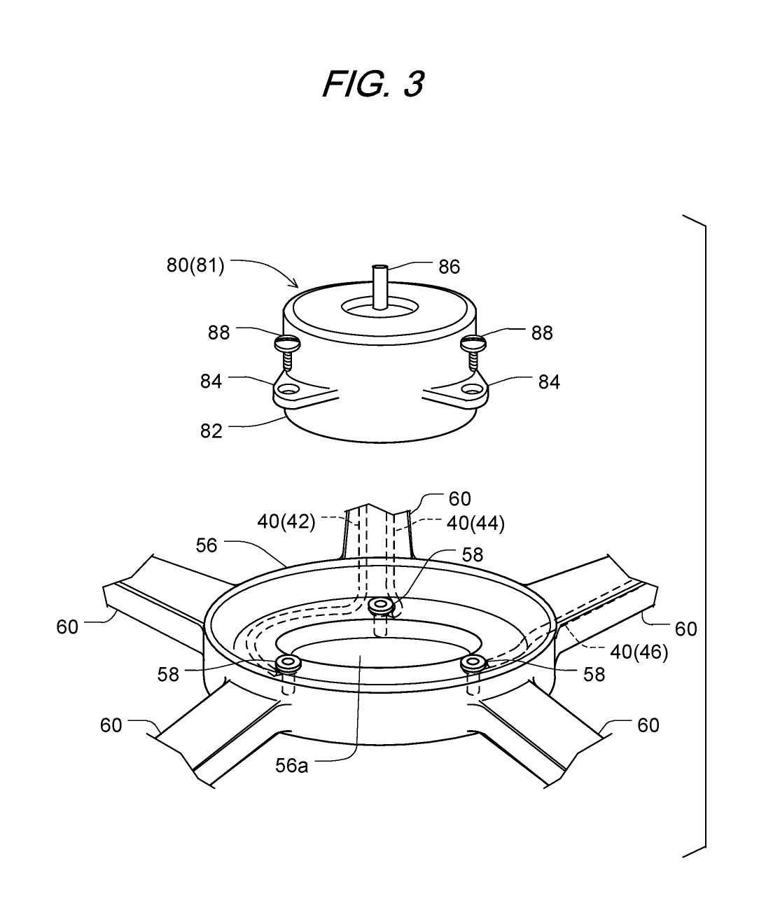

FIG. 2 shows the fan shroud 50 and the motor 80 from which the fan 10 in FIG. 1 is detached. In FIG. 2, multiple wires 40 are shown by bold dotted lines. FIG. 3 shows the motor 80 to be equipped to the shroud ring 56 and arms 60 of the fan shroud 50. In FIG. 3, the wires 40, which are embedded in the shroud ring 56 and the arms 60, are shown by dotted lines substantially in actual shapes.

As shown in FIGS. 2 and 3, the motor 80 is electrically connected with the wires 40 via the terminals 58, respectively, when being mounted to the fan shroud 50. The motor 80 includes the motor body 81 and multiple tabs 84. Each of the tabs 84 is in a triangular plate shape and extends from the motor cover 82 radially outward. Each of the tabs 84 includes a motor electrode, which is conductive and is connected with the internal wire 40. The motor cover 82 is formed of resin. The motor cover 82 electrically isolates the motor electrodes of the tabs 84 from each other. The tab 84 may be formed of metal. In this case, the tab 84 may function as the motor electrode.

The shroud ring 56 is embedded with the terminals 58 each formed of a conductive material. The terminals 58 are electrically connected with the wires 40, respectively. The wires 40 are further connected with the connector pins 74 of the connector 70 (FIG. 2). In the state in which the motor 80 is mounted on the shroud ring 56 via the tabs 84, the terminals 58 are electrically connected with the motor electrodes of the tab 84, respectively. In this state, the internal windings and the internal wiring of the motor 80 is connected with the connector pins 74 of the connector 70 through the motor electrodes of the tabs 84, the terminals 58, and the wires 40.

As shown by the dotted lines in FIG. 2, the wires 40 extend from the terminals 58 through the shroud ring 56 and the arms 60 to the connector pins 74 of the connector 70. The wires 40 are integrally molded with the shroud ring 56, the arm 60, and the shroud body 52, such that the wires 40 are embedded in the shroud ring 56, the arm 60, and the shroud body 52. In the present example, the wires 40 include a first wire 42, a second wire 44, and a third wire 46. The first wire 42 extends from the corresponding one terminal 58 along the periphery of the shroud ring 56 through the corresponding one arm 60 and further extends along the outer periphery of the shroud body 52 to corresponding one connector pin 74 of the connector 70. The second wire 44 extends from the corresponding one terminal 58 directly through the corresponding one arm 60 and further extends along the outer periphery of the shroud body 52 to corresponding one connector pin 74 of the connector 70. The third wire 46 extends from the corresponding one terminal 58 along the periphery of the shroud ring 56 through the corresponding one arm 60 and an intermediate portion of the shroud body 52 to corresponding one connector pin 74 of the connector 70.

In the example, the first and second wires 42 and 44 are embedded in the singular one arm 60. In the example, each wire 40 is integrally molded with the arm 60, which is closest one to the connector 70. In this way, the wire 40 is arranged to take a shortest path to the connector 70.

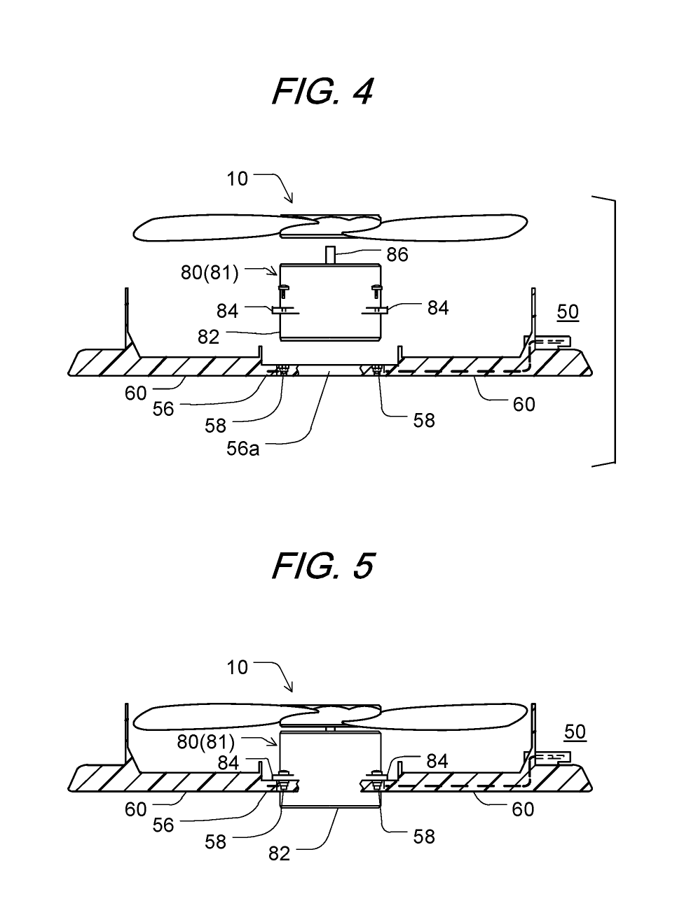

FIGS. 3 and 4 show a state before the motor 80 is mounted to the shroud ring 56. In the present example, each of the terminals 58 is in a pin shape. The wire 40 is, for example, crimpled to the terminal 58. The terminals 58 and the wires 40 are integrally molded with the shroud ring 56 and the arms 60, such that the terminals 58 are exposed from the shroud ring 56 at upper ends, and such that the wires 40 are embedded in the arms 60 to extend through the arms 60.

The shroud ring 56 has a center hole 56a in a circular shape. The center hole 56a has an inner diameter, which is greater than the outer diameter of the motor body 81. When the motor 80 is mounted to the shroud ring 56, the bottom of the motor body 81 is inserted through the center hole 56a of the shroud ring 56, such that a bottom portion of the motor cover 82 of the motor 80 extends through the center hole 56a of the shroud ring 56. Subsequently, the tabs 84 are placed on the terminals 58, respectively, such that the motor 80 is suspended on the shroud ring 56 via the tabs 84. In the present state, the motor 80 is electrically connected with the terminals 58 via the electrodes of the tabs 84. Fasteners 88 are screwed through the tabs 84 into screw holes of the terminals 58, respectively.

The fan 10 is mounted to the shaft 86 of the motor 80. Thus, as shown in FIG. 5, the fan shroud 50 device is assembled into one component.

The fan shroud 50 device assembled in this way may be placed, as one component of the CFRM, in an engine compartment of the vehicle. The external cable of the vehicle may be coupled with the connector 70 of the fan device installed in the vehicle.

Subsequently, a method for manufacturing the fan shroud 50 will be described. According to the present example, the terminals 58, the wires 40, and the connector 70 are insert-molded of resin in a condition where the terminals 58, the wires 40, and the connector pins 74 are electrically connected with each other by, for example, crimping, soldering, and/or welding, to form a wire harness assembly 30.

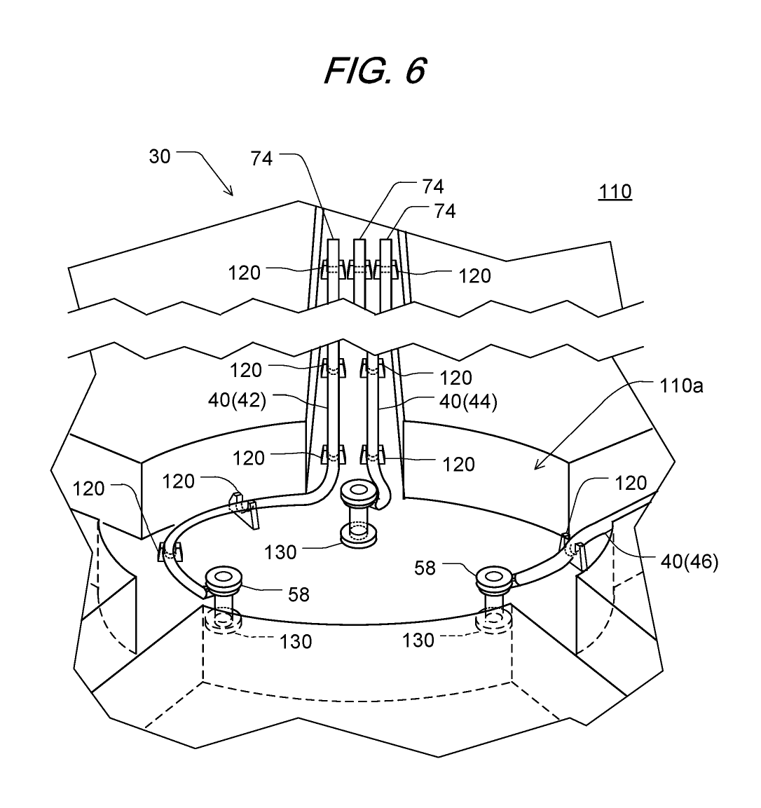

Subsequently, as shown in FIG. 6, the wire harness assembly 30 is located in a molding die 110 for molding the fan shroud 50. The wires 40 are positioned in a portion of a molding cavity 110a, which is for molding an arm 60. In the present example, the terminals 58, the wires 40, and the connector pins 74 are supported by jigs 120 and 130 formed on a bottom surface of the molding die 110. In this way, the jigs 120 and 130 may be used to support the wire 40, the connector pins 74, and the terminals 58 against a flow of resin. Subsequently, resin is injected into the molding cavity 110a thereby to insert mold the wire harness assembly 30 in the fan shroud 50. Thus, the fan shroud 50 is molded such that the wires 40 are insert-molded at predetermined positions in the shroud ring 56, the arms 60, and the shroud body 52.

Each of the jigs 120 may be in a U-shape and configured to be fitted to the outer surface of the wire 40 or the outer surface of the connector pin 74. The jig 120 may be in a wedge form reducing in width to the tip end to facilitate removal of the molded product from the molding die 110. The jig 130 for the terminal 58 may be in a ring shape and configured to be fitted to the tip end of the terminal 58. The jigs 120 for the wires 40 and the connector pins 74 and the jigs 130 for the terminals 58 may be protruded integrally from the bottom surface of the molding die 110. The installation of the wire harness assembly 30 into the molding cavity 110a may be implemented in an automated process or in a manual process by a human worker.

As described above, by injecting resin into the molding cavity 110a of the molding die 110, in which the wire harness assembly 30 is installed beforehand, the wire harness assembly 30 is insert-molded in the molded product of the fan shroud 50.

According to the present embodiment, the wire harness assembly 30 are integrally molded with the fan shroud 50. Therefore, the present structure may enable to protect the wire harness assembly 30, in particular the wires 40, from heat emitted from an engine and other components and to cause the resin material of the fan shroud 50 to insulate the wires 40, the terminals 58, and the connector pins 74 electrically from other components. The present structure may reduce manufacturing time and cost for the fan shroud 50 caused by routing the wires 40 on the fan shroud 50 in a relatively narrow engine compartment.

### Second Embodiment

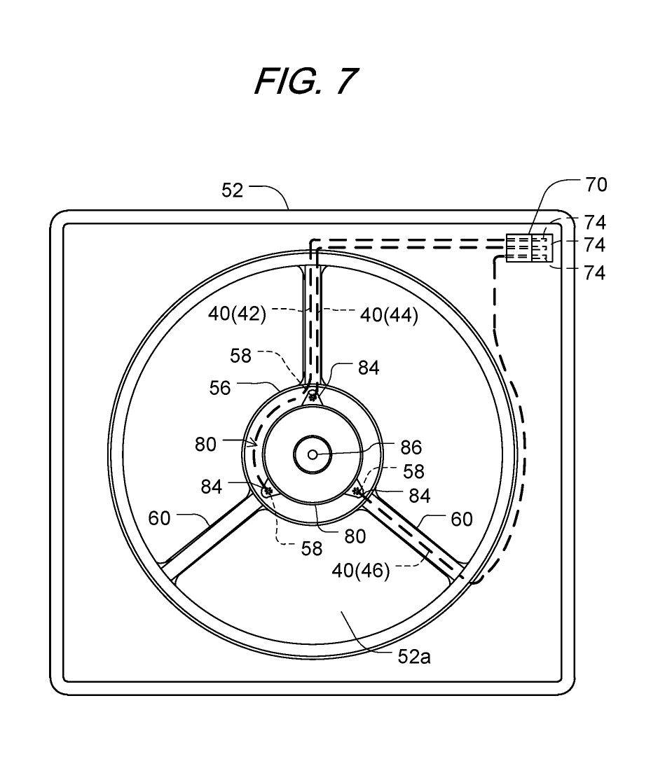

As shown in FIG. 7, according to the second embodiment, the arms 60 include three arms 60, which are located at a constant angular interval of 120 degrees. The first wire 42 extends along the periphery of the center hole 56a of the shroud ring 56. In the present example, the third wire 46 extends along the periphery of the hollow space 52a. In this way, the wire 40 may be arranged to take short path by passing through a closest arm 60.

### Third Embodiment

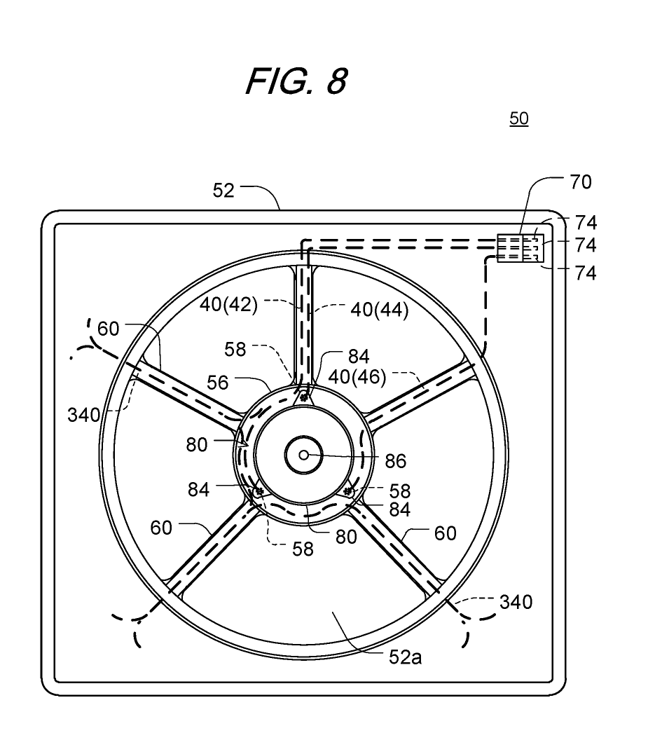

As shown in FIG. 8, according to the third embodiment, dummy wires 340 are integrally molded with arms 60, which do not include the first to third wires 40. That is, all the arms 60 are integrally molded with at least one of the first to third wires 40 or at least one of the dummy wires 340. The dummy wire 340 extends through the arm 60 to connect the shroud ring 56 with the shroud body 52. The dummy wire 340 is not connected with the terminal 58. A singular dummy wire 340 may extend through two arms 60 and the shroud ring 56. The dummy wire 340 may branch into two or more ends in the shroud body 52 or in the shroud ring 56. The present structure may render the arms 60 to have a uniform mechanical strength.

### Other Embodiment

At least one of the shroud body 52, the shroud ring 56, the arms 60, and the connector 70 may be separately molded of resin from the other component(s).

The number of the arms 60 may be arbitrarily determined in consideration of various factors such as an amount airflow and/or a mechanical strength of the fan shroud 50. The number of the wires 40 may be arbitrarily determined in consideration of various factors such as a type of the motor 80 and electrical components equipped to the fan shroud 50.

The motor 80 may be a three-phase alternate current motor 80 configured to be supplied with three-phase alternate current. In this case, the wires 40 may include three wires 40 corresponding to the three-phase alternate current.

The wires 40 may be integrally molded with the arms 60, respectively. Specifically, for example, the wires 40 include three wires 40, which are integrally molded with three arms 60, respectively. At least two wires 40 may be integrally molded with one of the arms 60.

In the above-described embodiments, a brushless motor is used as the motor 84. However, a brush motor that does not use a signal wire may be used as the motor 84.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fan shroud comprising:
a shroud body having a hollow space;
a shroud ring located in the hollow space;
a plurality of arms radially extending in the hollow space and connecting the shroud body with the shroud ring;
a plurality of terminals electrically conductive and equipped to the shroud ring; and
a plurality of wires electrically connected with the terminals, wherein
at least one of the wires is integrally molded with at least one of the arms.

2. The fan shroud according to claim 1, wherein
the shroud ring and the arms are integrally molded of resin, and
the at least one wire is integrally molded with the shroud ring.

3. The fan shroud according to claim 2, wherein
the shroud ring has a center hole at a center, and
the at least one wire extends along a periphery of the center hole.

4. The fan shroud according to claim 1, wherein
at least one of the terminals is integrally molded with the shroud ring.

5. The fan shroud according to claim 1, wherein
the shroud body and the arms are integrally molded of resin, and
the at least one wire is integrally molded with the shroud body.

6. The fan shroud according to claim 1, further comprising:
a connector including a plurality of connector pins each being conductive, wherein
the connector pins are insert-molded with the connector and integrally molded with the shroud body, and
the connector pins are electrically connected with the terminals through the wires.

7. The fan shroud according to claim 1, wherein
the arms include one arm closest to the connector, and
the one arm is integrally molded with the at least one wire.

8. The fan shroud according to claim 1, wherein
the terminals, the wires, and the connector are integrally molded of resin in a condition where the terminals, the wires, and the connector pins are electrically connected with each other.

9. The fan shroud according to claim 1, wherein
the at least one wire extends along a periphery of the hollow space.

10. The fan shroud according to claim 1, further comprising:
a dummy wire integrally molded with one of the arms, which is other than the at least one arm with which the at least one of the wires is integrally molded.

11. The fan shroud according to claim 1, wherein
at least two of the wires are integrally molded with one of the at least one arm.

12. The fan shroud according to claim 1, wherein
the wires include three wires,
the arms include three arms, and
the three wires are integrally molded with the three arms, respectively.

13. A fan device comprising:
the fan shroud according to claim 1; and
a motor mounted to the fan shroud and electrically connected with the wires via the terminals, respectively, wherein
the motor includes:
a motor body; and
a plurality of tabs extending radially outward from the motor body, wherein
the motor is electrically connected with the terminals through the tabs.

14. The fan device according to claim 13 wherein
the motor body is inserted into a center hole of the shroud ring, and
the motor is suspended on the shroud ring via the tabs.

15. The fan device according to claim 13 wherein
the motor body includes a motor cover formed of resin,
the tabs extend radially outward from the motor cover, and
the motor cover electrically isolates the tabs from each other.

16. The fan device according to claim 13 wherein
the motor is a direct current brushless motor, and
the wires include a positive wire, a negative wire, and a signal wire.

17. A method for molding a fan shroud, the method comprising:
connecting a plurality of terminals, a plurality of wires, and a plurality of connector pins, respectively;
locating the terminals, the wires, and the connector pins in a molding cavity of a molding die;
positioning at least one of the wires in a portion of the molding cavity, which is for molding an arm of the fan shroud; and
injecting resin into the molding die to insert-mold the at least one wire in the arm.

18. The method according to claim 17, wherein
the locating includes:
affixing at least one of the terminals, the wires, and the connector pins on a jig, which is formed in the molding die.
